(19) United States
(12) Patent Application Publication
(10) Pub. No.: US 2012/0242427 A1
(43) Pub. Date: Sep. 27, 2012

(54) HIGH-FREQUENCY CONVERSION CIRCUIT

(76) Inventor: Masatoshi SUZUKI, Yokohama-shi (JP)

(21) Appl. No.: 13/427,306

(22) Filed: Mar. 22, 2012

(30) Foreign Application Priority Data
Mar. 24, 2011 (JP) 2011-066659
Mar. 6, 2012 (JP) 2012-049406

(51) Int. Cl. H01P 1/00

(52) U.S. Cl. 333/250

(57) ABSTRACT

According to one embodiment, a high-frequency conversion circuit includes a conductor posts, a transmission path, and a path cutoff unit. The conductor posts form a waveguide that guides the high-frequency signal. The transmission path mode-converts the high-frequency signal output from a semiconductor circuit chip and guides the same to the waveguide. The path cutoff unit cuts off the path of a high-frequency current generated when the high-frequency signal output from the semiconductor circuit chip is transmitted to the waveguide via the transmission path.

### CROSS-REFERENCE TO RELATED APPLICATIONS

This application is based upon and claims the benefit of priority from prior Japanese Patent Applications No. 2011-066659, filed Mar. 24, 2011; and No. 2012-049406, filed Mar. 6, 2012, the entire contents of all of which are incorporated herein by reference.

### FIELD

Embodiments described herein relate generally to a high-frequency conversion circuit that mode-converts a high-frequency signal output from a semiconductor circuit chip, for example, and guides the same to a waveguide.

### BACKGROUND

For example, a system such as car radar that treats high-frequency electromagnetic waves as a signal (hereinafter referred to as a high-frequency signal) is provided. The system includes an element, for example, a semiconductor circuit chip that generates and amplifies a high-frequency signal and an antenna that receives a high-frequency signal output from the element. The system has a problem how to propagate the high-frequency signal when a signal line connecting the element to the antenna is realized.

Generally, when electromagnetic waves with frequencies up to approximately 18 GHz are treated, for example, a line structure such as a micro-strip line or coplanar line realized by forming a metal pattern on a given insulating body is used as the signal line connecting the element to the antenna.

In the frequency band exceeding the frequency of 18 GHz, since a part of signal energy is radiated into air from a substrate on which an element such as a semiconductor circuit chip is mounted, the transmission characteristic of a high-frequency signal is extremely degraded.

Therefore, a post wall waveguide (induction waveguide: that is hereinafter referred to as a post wall waveguide) that does not radiate the energy of a high-frequency signal into air is used. In the structure of the post wall waveguide, two ground layers are arranged in opposition to each other on an insulating substrate, a plurality of via-holes are arranged in two lines parallel to each other between the ground layers and a region in the insulating substrate surrounded by the ground layers and the via-holes of the two lines is formed as a transmission path equivalent to a waveguide.

In order to connect the post wall waveguide to the semiconductor circuit chip, a bonding wire is provided between the post wall waveguide and the semiconductor circuit chip and is used to connect them. Generally, a micro-strip line or coplanar line is formed in a pattern form on an insulating substrate. An impedance matching circuit is mounted on the micro-strip line or coplanar line. With the above structure, the inductivity of the bonding wire is set as that of a transmission path matched with the characteristic impedance of, for example, 50Ω and a mode conversion from the transmission path of 50Ω to the post wall waveguide is made.

### BRIEF DESCRIPTION OF THE DRAWINGS

FIG. 1 is an external configuration view showing a first embodiment of a high-frequency conversion circuit.

FIG. 2 is an external view of the conversion circuit as viewed from the side.

FIG. 3 is a schematic configuration view showing a waveguide in the conversion circuit.

FIG. 4 is an enlarged configuration view showing a mode conversion circuit in the conversion circuit.

FIG. 5 is a view showing the result of 3-dimensional electromagnetic simulation of a flow of a conductor surface current of a post wall waveguide in the conversion circuit.

FIG. 6 is a diagram showing the transmission characteristic and reflection characteristic of the conversion circuit for the frequency.

FIG. 7 is a configuration view showing a second embodiment of a high-frequency conversion circuit.

FIG. 8 is a configuration view showing a third embodiment of a high-frequency conversion circuit.

FIG. 9 is a configuration view showing a fourth embodiment of a high-frequency conversion circuit.

FIG. 10 is a configuration view showing a fifth embodiment of a high-frequency conversion circuit.

### DETAILED DESCRIPTION

In general, according to one embodiment, a high-frequency conversion circuit includes a waveguide substrate, a semiconductor circuit chip, a plurality of conductor posts, a transmission path, and a path cutoff unit. The semiconductor circuit chip is mounted on the waveguide substrate and outputs a high-frequency signal. The conductor posts are arranged in two lines on the waveguide substrate and form a waveguide that guides the high-frequency signal. The transmission path takes a linear form and is connected between the semiconductor circuit chip and the waveguide to mode-convert the high-frequency signal output from the semiconductor circuit chip and guide the same to the waveguide. The path cutoff unit is provided on the waveguide substrate and is electromagnetically connected to the transmission path to cut off the path of a high-frequency current generated when the high-frequency signal output from the semiconductor circuit chip is transmitted to the waveguide via the transmission path.

A first embodiment is explained below with reference to the drawings.

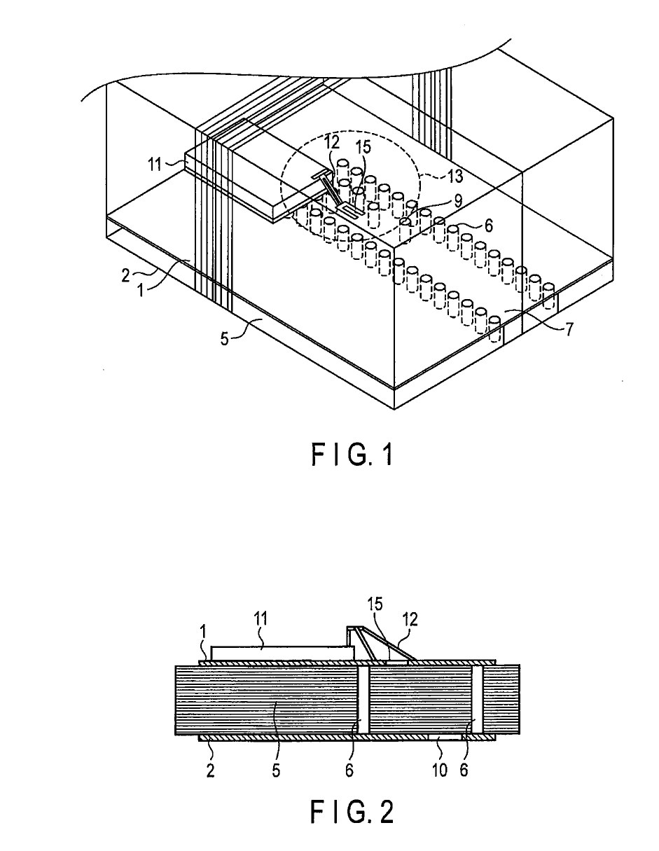

FIG. 1 to FIG. 3 are configuration views of a high-frequency conversion circuit. FIG. 1 is an external view and FIG. 2 is an external view of the high-frequency conversion circuit as viewed from the side.

The high-frequency conversion circuit includes millimeter-wave interposer substrate A as a waveguide substrate. The millimeter wave (milimetric wave) corresponds to an electromagnetic wave with a wavelength of 1 mm to 1 cm and a frequency of 30 to 300 GHz. Millimeter-wave interposer substrate A includes two ground layers 1, 2 and insulating substrate 5. The ground layers 1, 2 are arranged to face each other. Each of the ground layers 1, 2 is formed of a conductor. The insulating substrate 5 is disposed between the ground layers 1 and 2. The insulating substrate 5 is formed of a single-layered resin substrate or the like.

A plurality of via-holes 6 used as conductor posts are arranged in two lines parallel to each other between the ground layers 1 and 2. A transmission path (hereinafter referred to as a post wall waveguide) 7 is formed of a region surrounded by the via-holes 6 and ground layers 1, 2. The post wall waveguide 7 is a transmission path equivalent to a waveguide that guides a high-frequency signal.

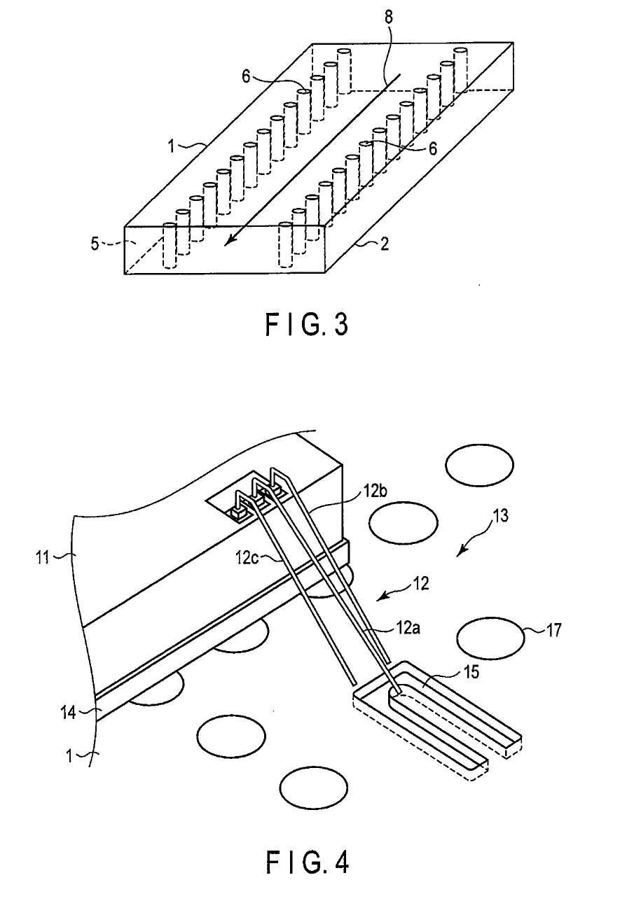

FIG. 3 is a schematic configuration view showing the post wall waveguide 7. The post wall waveguide 7 includes a transmission path 8 for the high-frequency signal between the lines of the via-holes 6 arranged parallel to each other. As shown in FIG. 1, a plurality of via-holes 9 for impedance matching are arranged between the lines of the via-holes 6. As shown in FIG. 2, a connection circuit 10 is provided on the ground layer 2. The connection circuit 10 connects the post wall waveguide 7 to an antenna feeder by means of a waveguide.

A semiconductor circuit chip (millimeter-wave MMIC) 11 is mounted on the ground layer 1. The semiconductor circuit chip 11 outputs a millimeter-wave high-frequency signal.

A bonding wire 12 that is a linear transmission line is connected between the output terminal of the semiconductor circuit chip 11 and the upper portion of the ground layer 1 to realize a high-frequency signal-ground transmission line by means of the bonding wire 12. The bonding wire 12 connects the output terminal (electrode terminal) of the semiconductor circuit chip 11 and the upper portion of the ground layer 1 via-bonding. The bonding wire 12 mode-converts the high-frequency signal output from the semiconductor circuit chip 11 and guides the same to the post wall waveguide 7.

The mode conversion operation is to convert the mode of the high-frequency signal output from the semiconductor circuit chip 11 to the mode of a signal to be transmitted via the post wall waveguide 7. With the above configuration, a mode conversion circuit 13 is formed between the output terminal of the semiconductor circuit chip 11 and the ground layer 1 via the bonding wire 12.

FIG. 4 is an enlarged configuration view showing the mode conversion circuit 13. The bonding wire 12 in the mode conversion circuit 13 includes one bonding wire 12a for a millimeter-wave signal and two bonding wires 12b, 12c for grounding. The bonding wire 12a for the millimeter-wave signal is arranged between the two grounding bonding wires 12b and 12c. The bonding wire 12a for the millimeter-wave signal is connected to the output terminal (electrode terminal) of the semiconductor circuit chip 11. The bonding wire 12a for the millimeter-wave signal transmits a high-frequency signal output from the semiconductor circuit chip 11. The two grounding bonding wires 12b, 12c are grounded (0 V). The semiconductor circuit chip 11 is mounted on the ground layer 1 via a die mounting paste 14.

A concave-form mode conversion opening 15 is formed in the ground layer 1. The mode conversion opening 15 cuts off the path of a high-frequency current generated when the high-frequency signal output from the semiconductor circuit chip 11 is transmitted to the post wall waveguide 7 via the bonding wire 12a for the millimeter-wave signal and absorbs discontinuity of the transmission mode of the high-frequency signal generated in the bonding wire 12a for the millimeter-wave signal. As a result, the mode conversion circuit 13 electromagnetically connects the transmission paths of the mode conversion opening 15 and the bonding wire 12a for the millimeter-wave signal by connecting the bonding wire 12a for the millimeter-wave signal to a conductor layer around the mode conversion opening 15.

The bonding wire 12a for the millimeter-wave signal extends over the mode conversion opening 15 toward the connection circuit 10 from the semiconductor circuit chip 11 as shown in FIG. 4, for example, and is connected to the ground layer 1. The two grounding bonding wires 12b, 12c extend toward the connection circuit 10 from the semiconductor circuit chip 11 and are connected to the ground layer 1 in front of the mode conversion opening 15.

The mode conversion opening 15 is formed in a location to cut off the path of a high-frequency current generated when a high-frequency signal output from the semiconductor circuit chip 11 is transmitted to the post wall waveguide 7 via the bonding wire 12a for the millimeter-wave signal as described above.

The length of the mode conversion opening 15 in a direction in which the path of the high-frequency current is cut off is set to substantially half the wavelength at the center frequency of the high-frequency signal.

The mode conversion opening 15 is formed with the center thereof set in substantially conformity with the central position of the post wall waveguide 7 in the width direction. The mode conversion opening 15 may be formed with the center thereof separated from the center of the post wall waveguide 7 in the width direction by a preset distance.

A high-frequency current on the conductor surface of the post wall waveguide 7 is explained.

The mode conversion operation is considered possible by forming a structure in which a high-frequency current propagated from the bonding wire 12a can excite the same current as a high-frequency current of the conductor surface of the post wall waveguide 7.

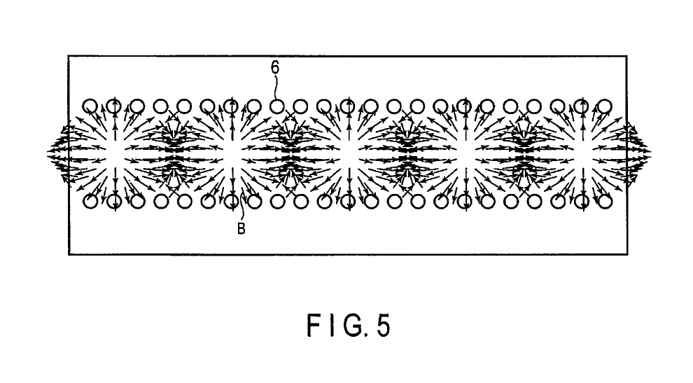

A flow of the high-frequency current is obtained by means of a three-dimensional electromagnetic simulator to confirm the flow of a current of the conductor surface of the post wall waveguide 7. FIG. 5 shows the simulation result of a flow of the high-frequency current. Vector B of the high-frequency current spreads to well up from a given point and propagates to be absorbed into a given point. The distance between the given points is half the wavelength of the high-frequency signal. Based on the simulation result, the mode conversion opening 15 is provided in a desired location slightly deviated from the central position of the post wall waveguide 7 in the waveguide width direction in order to make it easy for the high-frequency current propagating from the bonding wire 12a to propagate as shown by vector B.

The mode conversion opening 15 is formed in an opening with a concave-form pattern as described above. The high-frequency current flows along the concave-form mode conversion opening 15. A current having the same vector as that of the surface current of the post wall waveguide 7, that is, having the same direction of flow and magnitude as those of the surface current of the post wall waveguide 7 can be excited by the high-frequency current flowing along the mode conversion opening 15. That is, if the high-frequency current flows along the concave-form mode conversion opening 15, a magnetic field is generated by a flow of the high-frequency current and a high-frequency current is generated by the magnetic field. The high-frequency current is transmitted with the high-frequency current that flows along the mode conversion opening 15 used as a wave source.

In order to further forcedly lead the electric field into the internal portion of the ground layer 1 from the mode conversion opening 15, a mode conversion assistant via-hole 17 is provided near the mode conversion opening 15. The electric field into the internal portion of the ground layer 1 is generated by a flow of the high-frequency current.

In the post wall waveguide 7, an impedance matching via-hole 9 is arranged. Impedance mismatching after the mode conversion is eliminated by means of the inductive operation by the impedance matching via-hole 9.

Thus, according to the first embodiment, the bonding wire 12 is connected between the output terminal of the semiconductor circuit chip 11 and the upper portion of the ground layer 1 and the mode of the high-frequency signal output from the semiconductor circuit chip 11 is converted to a mode in which the signal is transmitted to the post wall waveguide 7 by means of the mode conversion circuit 13. The mode conversion opening 15 is formed in the mode conversion circuit 13, the bonding wire 12a for the millimeter-wave signal is connected to the conductor layer around the mode conversion opening 15 and the transmission paths of the mode conversion opening 15 and the bonding wire 12a for the millimeter-wave signal are electromagnetically coupled. As a result, the path of the high-frequency current generated when the high-frequency signal output from the semiconductor circuit chip 11 passes through the bonding wire 12a for the millimeter-wave signal and is transmitted to the post wall waveguide 7 via the mode conversion opening 15 is cut off by the mode conversion opening 15 and discontinuity of the transmission mode of the high-frequency signal occurring in the bonding wire 12a for the millimeter-wave signal is absorbed. As a result, the semiconductor circuit chip 11 and the post wall waveguide 7 are connected to each other without causing discontinuity in high frequencies and high-quality signal transfer can be attained.

According to the first embodiment, an inexpensive millimeter-wave high-frequency conversion circuit can be realized in which it is not necessary to perform the mode conversion operation twice, the transmission characteristic of the millimeter-wave signal is not degraded due to the loss of the two mode conversion operations and the high-frequency signal can be propagated from the semiconductor circuit chip 11 to the post wall waveguide 7 by one mode conversion operation.

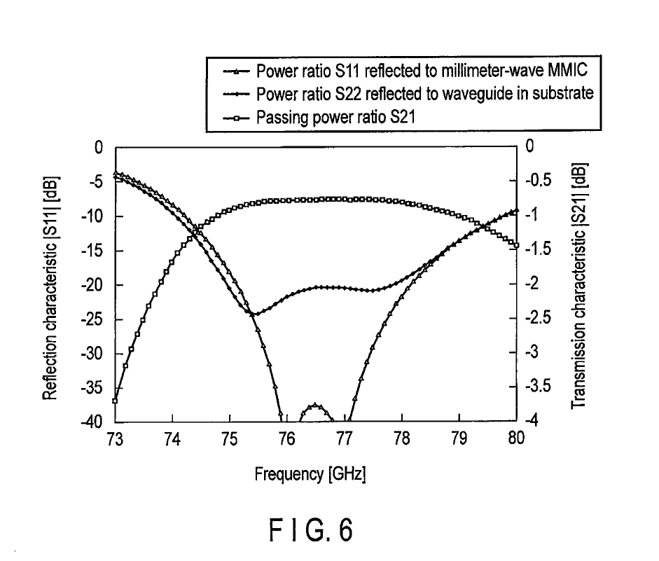

FIG. 6 shows the transmission characteristic and reflection characteristic for the frequency. As shown in the drawing, it can be confirmed that a preferable characteristic is obtained in which the reflection characteristic ≦−20 dB and the transmission characteristic ≧−0.8 dB are attained in the frequency band of 76 to 77 GHz used in car radar, for example. Thus, a millimeter-wave high-frequency conversion circuit module of a simple structure and low cost having a preferable characteristic can be realized.

Next, a second embodiment is explained with reference to the drawing.

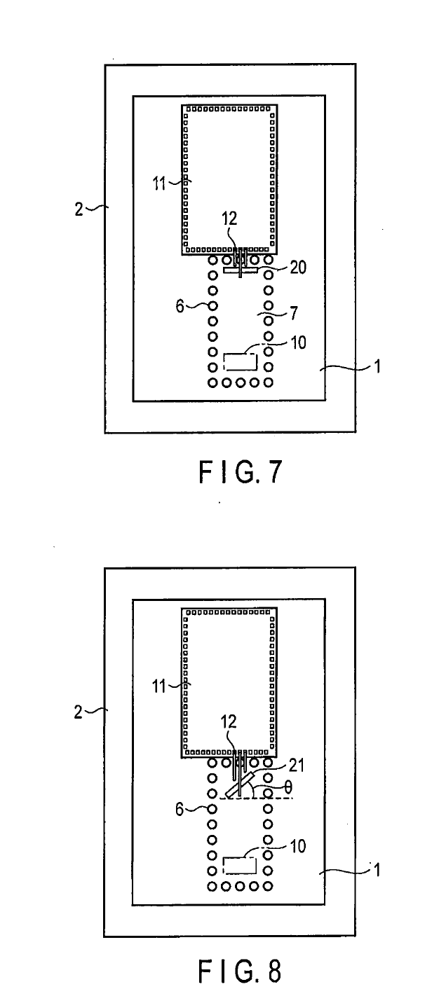

FIG. 7 is a configuration view of a high-frequency conversion circuit. In the drawing, the same portions as those of FIG. 1 to FIG. 4 are denoted by the same symbols and the explanation thereof is omitted. A linear mode conversion opening 20 is formed in a ground layer 1. The mode conversion opening 20 is formed in a vertical direction with respect to a direction of a transmission path 8 formed from a bonding wire 12a for a millimeter-wave signal toward a post wall waveguide 7. The mode conversion opening 20 cuts off a path of a high-frequency current generated when a high-frequency signal output from a semiconductor circuit chip 11 is transmitted to the post wall waveguide 7 via the bonding wire 12a for the millimeter-wave signal and absorbs discontinuity of a transmission mode of the high-frequency signal generated in the bonding wire 12a for the millimeter-wave signal. A mode conversion circuit 13 electromagnetically couples the transmission paths of the mode conversion opening 20 and the bonding wire 12a for the millimeter-wave signal by connecting the bonding wire 12a for the millimeter-wave signal to a conductor layer around the linear mode conversion opening 20.

The bonding wire 12a for the millimeter-wave signal extends over the mode conversion opening 20 toward the connection circuit 10 from the semiconductor circuit chip 11 and is connected to the ground layer 1. Two grounding bonding wires 12b, 12c extend toward the connection circuit 10 from the semiconductor circuit chip 11 and are connected to the ground layer 1 in front of the mode conversion opening 20.

As described before, the mode conversion opening 20 is provided in a location where the path of a high-frequency current generated when the high-frequency signal output from the semiconductor circuit chip 11 is transmitted to the post wall waveguide 7 via the bonding wire 12a for the millimeter-wave signal is cut off.

The mode conversion opening 20 is formed to set the length thereof in a direction in which the path of the high-frequency current is cut off to substantially half the wavelength at the center frequency of the high-frequency signal.

The mode conversion opening 20 is formed with the center thereof set in substantially conformity with the center of the post wall waveguide 7 in the width direction. The mode conversion opening 20 may be formed with the center thereof separated from the center of the post wall waveguide 7 in the width direction by a preset distance.

Thus, even if the linear mode conversion opening 20 is used, the same effect as that of the first embodiment can be attained.

Next, a third embodiment is explained with reference to the drawing.

FIG. 8 is a configuration view of a high-frequency conversion circuit. In the drawing, the same portions as those of FIG. 1 to FIG. 4 are denoted by the same symbols and the explanation thereof is omitted. A linear mode conversion opening 21 is formed in a ground layer 1. The mode conversion opening 21 is inclined at preset angle θ, for example, approximately 60° with respect to a direction of a transmission path 8 formed from a bonding wire 12a for a millimeter-wave signal toward a post wall waveguide 7.

The mode conversion opening 21 cuts off a path of a high-frequency current generated when a high-frequency signal output from a semiconductor circuit chip 11 is transmitted to the post wall waveguide 7 via the bonding wire 12a for the millimeter-wave signal and absorbs discontinuity of a transmission mode of the high-frequency signal generated in the bonding wire 12a for the millimeter-wave signal. A mode conversion circuit 13 electromagnetically couples the transmission paths of the inclined mode conversion opening 21 and the bonding wire 12a for the millimeter-wave signal by connecting the bonding wire 12a for the millimeter-wave signal to a conductor layer around the inclined mode conversion opening 21.

The bonding wire 12a for the millimeter-wave signal extends over the mode conversion opening 21 toward a connection circuit 10 from the semiconductor circuit chip 11 and is connected to the ground layer 1. Two grounding bonding wires 12b, 12c extend toward the connection circuit 10 from the semiconductor circuit chip 11 and are connected to the ground layer 1 in front of the mode conversion opening 21.

As described before, the mode conversion opening 21 is provided in a location where the path of a high-frequency current generated when the high-frequency signal output from the semiconductor circuit chip 11 is transmitted to the post wall waveguide 7 via the bonding wire 12a for the millimeter-wave signal is cut off.

The mode conversion opening 21 is formed to set the length thereof in a direction in which the path of the high-frequency current is cut off to substantially half the wavelength at the center frequency of the high-frequency signal.

The mode conversion opening 21 is formed with the center thereof set in substantially conformity with the center of the post wall waveguide 7 in the width direction. The mode conversion opening 21 may be formed with the center thereof separated from the center of the post wall waveguide 7 in the width direction by a preset distance.

Thus, even if the inclined mode conversion opening 21 is used, the same effect as that of the first embodiment can be attained.

Next, a fourth embodiment is explained with reference to the drawing. The same portions as those of FIG. 1 to FIG. 4 are denoted by the same symbols and the explanation thereof is omitted.

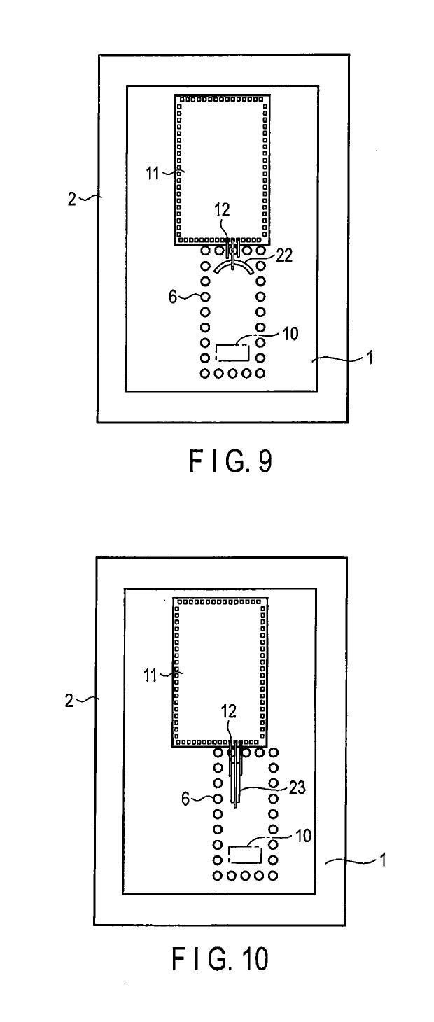

FIG. 9 is a configuration view of a high-frequency conversion circuit. In the drawing, the same portions as those of FIG. 1 to FIG. 4 are denoted by the same symbols and the explanation thereof is omitted. A mode conversion opening 22 of a curved (arc) shape obtained by bending a straight line is formed in a ground layer 1. The mode conversion opening 22 cuts off a path of a high-frequency current generated when a high-frequency signal output from a semiconductor circuit chip 11 is transmitted to a post wall waveguide 7 via a bonding wire 12a for a millimeter-wave signal and absorbs discontinuity of a transmission mode of the high-frequency signal generated in the bonding wire 12a for the millimeter-wave signal.

A mode conversion circuit 13 electromagnetically couples the transmission paths of the curved mode conversion opening 22 and the bonding wire 12a for the millimeter-wave signal by connecting the bonding wire 12a for the millimeter-wave signal to a conductor layer around the curved mode conversion opening 22.

As described before, the mode conversion opening 22 is provided in a location where the path of a high-frequency current generated when the high-frequency signal output from the semiconductor circuit chip 11 is transmitted to the post wall waveguide 7 via the bonding wire 12a for the millimeter-wave signal is cut off.

The bonding wire 12a for the millimeter-wave signal extends over the mode conversion opening 22 toward a connection circuit 10 from the semiconductor circuit chip 11 and is connected to the ground layer 1. Two grounding bonding wires 12b, 12c extend toward the connection circuit 10 from the semiconductor circuit chip 11 and are connected to the ground layer 1 in front of the mode conversion opening 22.

The mode conversion opening 22 is formed to set the length thereof in a direction in which the path of the high-frequency current is cut off to substantially half the wavelength at the center frequency of the high-frequency signal.

The mode conversion opening 22 is formed with the center thereof set in substantially conformity with the center of the post wall waveguide 7 in the width direction. The mode conversion opening 22 may be formed with the center thereof separated from the center of the post wall waveguide 7 in the width direction by a preset distance.

Thus, even if the curved mode conversion opening 22 is used, the same effect as that of the first embodiment can be attained.

Next, a fifth embodiment is explained with reference to the drawing.

FIG. 10 is a configuration view of a high-frequency conversion circuit. In the drawing, the same portions as those of FIG. 1 to FIG. 4 are denoted by the same symbols and the explanation thereof is omitted. A linear mode conversion opening 23 is formed in a ground layer 1. The mode conversion opening 23 is formed in the same direction as a direction of a transmission path 8 extending from a bonding wire 12a for a millimeter-wave signal toward a post wall waveguide 7. The mode conversion opening 23 cuts off a path of a high-frequency current generated when a high-frequency signal output from a semiconductor circuit chip 11 is transmitted to the post wall waveguide 7 via the bonding wire 12a for the millimeter-wave signal and absorbs discontinuity of a transmission mode of the high-frequency signal generated in the bonding wire 12a for the millimeter-wave signal.

A mode conversion circuit 13 electromagnetically couples the transmission paths of the linear mode conversion opening 23 and the bonding wire 12a for the millimeter-wave signal by connecting the bonding wire 12a for the millimeter-wave signal to a conductor layer around the linear mode conversion opening 23.

The bonding wire 12a for the millimeter-wave signal extends over the mode conversion opening 23 toward a connection circuit 10 from the semiconductor circuit chip 11 and is connected to the ground layer 1. Two grounding bonding wires 12b, 12c extend toward the connection circuit 10 from the semiconductor circuit chip 11 and are connected to the ground layer 1 in front of the mode conversion opening 23.

As described before, the mode conversion opening 23 is provided in a location where the path of a high-frequency current generated when the high-frequency signal output from the semiconductor circuit chip 11 is transmitted to the post wall waveguide 7 via the bonding wire 12a for the millimeter-wave signal is cut off.

The mode conversion opening 23 is formed to set the length thereof in a direction in which the path of the high-frequency current is cut off to substantially half the wavelength at the center frequency of the high-frequency signal.

The mode conversion opening 23 is formed with the center thereof set in substantially conformity with the center of the post wall waveguide 7 in the width direction thereof. The mode conversion opening 23 may be formed with the center thereof separated from the center of the post wall waveguide 7 in the width direction by a preset distance.

Thus, even if the linear mode conversion opening 23 is used, the same effect as that of the first embodiment can be attained.

The high-frequency conversion circuit is not limited to the first to fifth embodiments and can be modified as follows.

The mode conversion openings 15, 20 to 23 may be formed with a rectangular, circular, square or bent shape.

The length of the mode conversion openings 15, 20 to 23 in a direction in which the path of the high-frequency current is cut off may be set to an integral multiple of substantially half the wavelength at the center frequency of the high-frequency signal.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A high-frequency conversion circuit comprising:
a waveguide substrate,
a semiconductor circuit chip mounted on the waveguide substrate and configured to output a high-frequency signal,
a plurality of conductor posts arranged in two lines on the waveguide substrate and forming a waveguide that guides the high-frequency signal,
a transmission path formed in a linear form and connected between the semiconductor circuit chip and the waveguide to mode-convert the high-frequency signal output from the semiconductor circuit chip and guide the same to the waveguide, and
a path cutoff unit provided on the waveguide substrate and electromagnetically coupled with the transmission path to cut off a path of a high-frequency current generated when the high-frequency signal output from the semiconductor circuit chip is transmitted to the waveguide via the transmission path.

2. The high-frequency conversion circuit according to claim 1,
wherein the path cutoff unit includes an opening formed in one of a rectangular form, circular form, square form, bent form and curved form.

3. The high-frequency conversion circuit according to claim 2,
wherein length of the opening in a direction to cut off the path of the high-frequency current is set to substantially half the wavelength at the center frequency of the high-frequency signal.

4. The high-frequency conversion circuit according to claim 2,
wherein length of the opening in a direction to cut off the path of the high-frequency current is set to an integral multiple of substantially half the wavelength at the center frequency of the high-frequency signal.

5. The high-frequency conversion circuit according to claim 2,
wherein the opening is provided with a center thereof set in substantially conformity with a central position of the waveguide in a width direction.

6. The high-frequency conversion circuit according to claim 2,
wherein a lengthwise direction of the rectangular form of the opening is inclined at a preset angle with respect to a width direction of the waveguide.

7. The high-frequency conversion circuit according to claim 6,
wherein the lengthwise direction of the rectangular form of the opening is inclined at an angle that is not larger than 60° as the preset angle.

8. The high-frequency conversion circuit according to claim 2,
wherein the opening is separated from the central position of the waveguide in the width direction by a preset distance.

9. The high-frequency conversion circuit according to claim 1,
wherein the linear transmission path includes a bonding wire.

10. The high-frequency conversion circuit according to claim 9,
wherein the bonding wire is connected to an upper portion of the waveguide substrate around the opening.

11. The high-frequency conversion circuit according to claim 1,
wherein the opening permits the high-frequency current to flow around the opening and excites a current having the same direction of flow and magnitude as those of a surface current of the transmission path by means of a flow of the high-frequency current.

12. The high-frequency conversion circuit according to claim 2,
wherein the opening cuts off a path of a high-frequency current generated when the high-frequency signal output from the semiconductor circuit chip is transmitted to the transmission path and absorbs discontinuity of a transmission mode of the high-frequency signal generated in the transmission path.

13. The high-frequency conversion circuit according to claim 1, further comprising:
a mode conversion assistant hole that is provided in the waveguide substrate near the opening and leads an electric field generated by a flow of the high-frequency current into an internal portion of the waveguide substrate from the opening.

14. The high-frequency conversion circuit according to claim 1, further comprising:
an impedance matching hole that is provided in the transmission path and eliminates impedance mismatching after the mode conversion.

15. The high-frequency conversion circuit according to claim 1,
wherein the linear transmission path includes a signal bonding wire and two grounding bonding wires,
the signal bonding wire being arranged between the grounding bonding wires, being connected to the output terminal of the semiconductor circuit chip and transmitting the high-frequency signal output from the semiconductor circuit chip,
the grounding bonding wires being grounded, and
the opening cutting off the path of the high-frequency current generated when the high-frequency signal output from the semiconductor circuit chip is transmitted to the waveguide via the signal bonding wire and absorbing discontinuity of a transmission mode of the high-frequency signal generated in the signal bonding wire.

16. The high-frequency conversion circuit according to claim 15,
wherein the signal bonding wire extends over the opening in a transmission direction of the high-frequency signal output from the semiconductor circuit chip and is connected to the waveguide substrate and
the grounding bonding wires are connected to the waveguide substrate in font of the opening in a transmission direction of the high-frequency signal output from the semiconductor circuit chip.
